(19) United States
(12) Patent Application Publication
(10) Pub. No.: US 2011/0010506 A1
(43) Pub. Date: Jan. 13, 2011

(54) DATA PREFETCHER WITH MULTI-LEVEL TABLE FOR PREDICTING STRIDE PATTERNS

(75) Inventors: John Michael Greer, Austin, TX (US); Rodney E. Hooker, Austin, TX (US); Albert J. Loper, JR., Austin, TX (US)

Correspondence Address: HUFFMAN LAW GROUP, P.C., 1900 MESA AVE., COLORADO SPRINGS, CO, 80906, US

(73) Assignee: VIA Technologies, Inc., Taipei (TW)

(21) Appl. No.: 12/573,462

(22) Filed: Oct. 5, 2009

Related U.S. Application Data
(60) Provisional application No. 61/224,781, filed on Jul. 10, 2009.

(51) Int. Cl. G06F 12/08; G06F 12/00; G06F 9/30

(52) U.S. Cl. 711/137; 712/207; 711/E12.001; 711/E12.057

(57) ABSTRACT

A data prefetcher includes a table of entries to maintain a history of load operations. Each entry stores a tag and a corresponding next stride. The tag comprises a concatenation of first and second strides. The next stride comprises the first stride. The first stride comprises a first cache line address subtracted from a second cache line address. The second stride comprises the second cache line address subtracted from a third cache line address. The first, second and third cache line addresses each comprise a memory address of a cache line implicated by respective first, second and third temporally preceding load operations. Control logic calculates a current stride by subtracting a previous cache line address from a new load cache line address, looks up in the table a concatenation of a previous stride and the current stride, and prefetches a cache line using the hitting table entry next stride.

### CROSS REFERENCE TO RELATED APPLICATION(S)

This application claims priority based on U.S. Provisional Application Ser. No. 61/224,781, filed Jul. 10, 2009, entitled PREFETCHING USING TWO-LEVEL TABLE TO PREDICT NEXT STRIDE BASED ON PATTERN OF STRIDES, which is hereby incorporated by reference in its entirety.

### FIELD OF THE INVENTION

The present invention relates in general to the field of microprocessors, and particularly to prefetching therein.

### BACKGROUND OF THE INVENTION

The notion of data prefetching in microprocessors is well known. Specifically, microprocessors attempt to detect a stream of program loads from sequential memory addresses and prefetch ahead in the stream of the program loads. However, program loads do not always access sequential memory locations, but instead often skip a fixed amount of data between the loaded data. The fixed distance between the loaded data is commonly referred to as the “stride” at which the program is loading data. Stride-detecting prefetch mechanisms in microprocessors are also well-known. However, conventional stride-detecting prefetch mechanisms rely on a single stride distance; whereas, the present inventors have observed that important programs exist that access data in a regular fashion, but not by a single stride distance. Conventional stride-detecting prefetch mechanisms are not able to accurately predict future load addresses exhibited by such programs.

### BRIEF SUMMARY OF INVENTION

In one aspect the present invention provides a data prefetcher in a microprocessor. The data prefetcher includes a table of entries configured for maintaining on a history of load operations. Each of the entries stores a tag and a corresponding next stride. The tag comprises a concatenation of first and second strides. The next stride comprises the first stride. The first stride comprises a first cache line address subtracted from a second cache line address. The second stride comprises the second cache line address subtracted from a third cache line address. The first, second and third cache line addresses each comprise a memory address of a cache line implicated by respective first, second and third temporally preceding load operations. The data prefetcher also includes control logic, coupled to the table of entries, configured to calculate a current stride by subtracting a previous cache line address from a new load cache line address, look up in the table a concatenation of a previous stride and the current stride, and prefetch a cache line at a prefetch cache line address calculated as a sum of the new load cache line address and the next stride of an entry of the table in which the concatenation of the previous stride and the current stride hits. The new load cache line address comprises a memory address of a cache line implicated by a new load operation. The previous cache line address comprises a memory address of a cache line implicated by a previous load operation that temporally precedes the new load operation. The previous stride is the previous cache line address subtracted from a previous-to-previous cache line address. The previous-to-previous cache line address comprises a memory address of a cache line implicated by a load operation that temporally precedes the previous load operation.

In another aspect, the present invention provides a method for prefetching data in a microprocessor. The method includes maintaining a table of entries based on a history of load operations, each of the entries storing a tag and a corresponding next stride. The tag comprises a concatenation of first and second strides. The next stride comprises the first stride. The first stride comprises a first cache line address subtracted from a second cache line address. The second stride comprises the second cache line address subtracted from a third cache line address. The first, second and third cache line addresses each comprise a memory address of a cache line implicated by respective first, second and third temporally preceding load operations. The method also includes calculating a current stride by subtracting a previous cache line address from a new load cache line address. The new load cache line address comprises a memory address of a cache line implicated by a new load operation. The previous cache line address comprises a memory address of a cache line implicated by a previous load operation that temporally precedes the new load operation. The method also includes looking up in the table a concatenation of a previous stride and the current stride. The previous stride is the previous cache line address subtracted from a previous-to-previous cache line address. The previous-to-previous cache line address comprises a memory address of a cache line implicated by a load operation that temporally precedes the previous load operation. The method also includes prefetching a cache line at a prefetch cache line address calculated as a sum of the new load cache line address and the next stride of an entry of the table in which the concatenation of the previous stride and the current stride hits.

In yet another aspect, the present invention provides a computer program product for use with a computing device, the computer program product comprising a computer usable storage medium having computer readable program code embodied in said medium for specifying a data prefetcher in a microprocessor. The computer readable program code includes first program code for specifying a table of entries configured for maintaining on a history of load operations. Each of the entries stores a tag and a corresponding next stride. The tag comprises a concatenation of first and second strides. The next stride comprises the first stride. The first stride comprises a first cache line address subtracted from a second cache line address. The second stride comprises the second cache line address subtracted from a third cache line address. The first, second and third cache line addresses each comprise a memory address of a cache line implicated by respective first, second and third temporally preceding load operations. The computer readable program code also includes second program code for specifying control logic, coupled to the table of entries, configured to calculate a current stride by subtracting a previous cache line address from a new load cache line address, look up in the table a concatenation of a previous stride and the current stride, and prefetch a cache line at a prefetch cache line address calculated as a sum of the new load cache line address and the next stride of an entry of the table in which the concatenation of the previous stride and the current stride hits. The new load cache line address comprises a memory address of a cache line implicated by a new load operation. The previous cache line address comprises a memory address of a cache line implicated by a previous load operation that temporally precedes the new load operation. The previous stride is the previous cache line address subtracted from a previous-to-previous cache line address. The previous-to-previous cache line address comprises a memory address of a cache line implicated by a load operation that temporally precedes the previous load operation.

### BRIEF DESCRIPTION OF THE DRAWINGS

FIG. 1 is a block diagram illustrating a microprocessor according to the present invention.

FIG. 2 is a block diagram illustrating the data prefetch engine of FIG. 1.

FIG. 3 is a block diagram illustrating one of the Stream Hardware Sets of FIG. 2 according to the present invention.

FIG. 4 is a flowchart illustrating operation of the data prefetch engine of FIG. 2 according to the present invention.

FIG. 5 is a table illustrating operation of the data prefetch engine of FIG. 2 according to the present invention.

### DETAILED DESCRIPTION OF THE INVENTION

Embodiments described herein provide a two-level table approach to stride prediction to improve the load prediction accuracy by the microprocessor when executing programs that access data in a regular fashion, but not by a single stride distance.

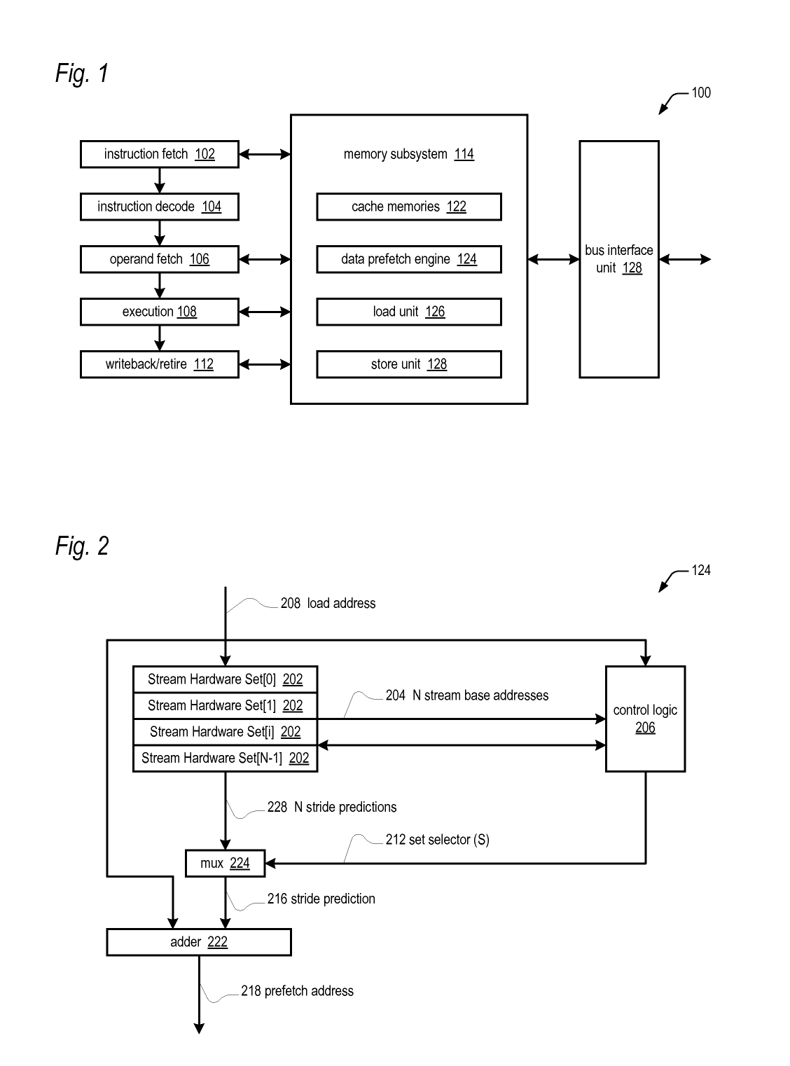

Referring now to FIG. 1, a block diagram illustrating a microprocessor 100 according to the present invention is shown. The microprocessor 100 includes well-known instruction fetch 102, instruction decode 104, operand fetch 106, execution 108, and result writeback/instruction retire 112 stages. Each stage shown may include multiple stages. In one embodiment, the microprocessor 100 is a superscalar out-of-order execution/in-order retirement microprocessor. The microprocessor 100 also includes a bus interface unit 128 for interfacing the microprocessor 100 to an external bus for accessing system memory and peripheral devices. The microprocessor 100 also includes a memory subsystem 114, which includes one or more cache memories 122, a data prefetch engine 124, a load unit 126, and a store unit 128.

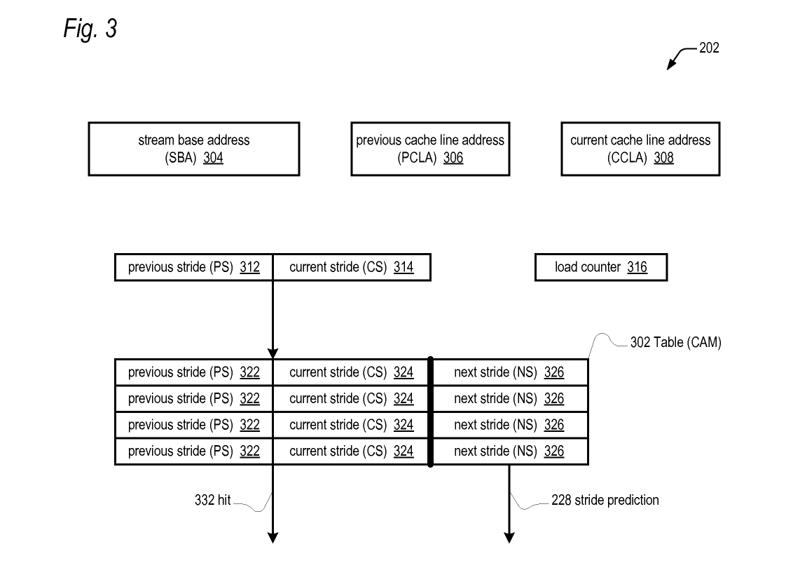

Referring now to FIG. 2, a block diagram illustrating the data prefetch engine 124 of FIG. 1 is shown. The data prefetch engine 124 includes a plurality of Stream Hardware Sets 202 coupled to control logic 206. The Stream Hardware Sets 202 receive a load address 208 specified by a load operation generated by other elements of the microprocessor 100. In one embodiment, the load address 208 is a 36-bit physical address, the size of a Stream, or memory region, is a 4 KB page, and the size of a cache line is 64 bytes. Thus, bits [35:12] specify a page number, bits [11:6] specify a cache line within the page, and bits [5:0] specify an offset within the cache line. Furthermore, SBA 304 (see FIG. 3) corresponds to bits [35:12] of the physical address; and PCLA 306, CCLA 308, PS 312, and CS 314 (see FIG. 3) correspond to bits [11:6] of the physical address. However, other embodiments are contemplated in which the Stream, or memory region, size is different than a 4 KB page size (e.g., 2 MB page or a region defined by traits in an MTRR or PAT tables specifying an arbitrary region defined by microcode) and different cache line sizes may be employed.

Each of the Stream Hardware Sets 202 provides a stream base address (SBA) 204 to the control logic 206 which, among other things, compares the SBAs 204 to the load address 208 and generates a value on a set selector (S) 212 to indicate the Stream Hardware Sets 202 whose SBA 204 matches the load address 208, if any. The set selector 212 is provided to a mux 224, which receives a stride prediction 228 (see FIG. 3) from each of the Stream Hardware Sets 202 and selects one of them indicated by the set selector 212 as a final stride prediction 216. An adder 222 adds the final stride prediction 216 to the load address 208 to generate a prefetch address 218.

Referring now to FIG. 3, a block diagram illustrating one of the Stream Hardware Sets 202 of FIG. 2 according to the present invention is shown. The Stream Hardware Set 202 includes a stream base address (SBA) register 304, a previous cache line address (PCLA) register 306, a current cache line address (CCLA) register 308, a previous stride (PS) register 312, a current stride (CS) register 314, a load counter 316, and a Table 302. The Table 302 is a content-addressable memory (CAM). Each entry in the Table 302 includes a tag field and a data field. The tag field is the concatenation of a previous stride (PS) subfield 322 and a current stride (CS) subfield 324. The data field is a next stride (NS) 326 field. When the Stream Hardware Set 202 is ready to make a stride prediction, it looks up the concatenation of the PS 312 and the CS 314 in the Table 302. If a match with a valid tag is found, a true value is output on a hit signal 332; otherwise a false value is output. If a hit occurs, Table 302 outputs the value of the NS field 326 of the matching entry on stride prediction output 228.

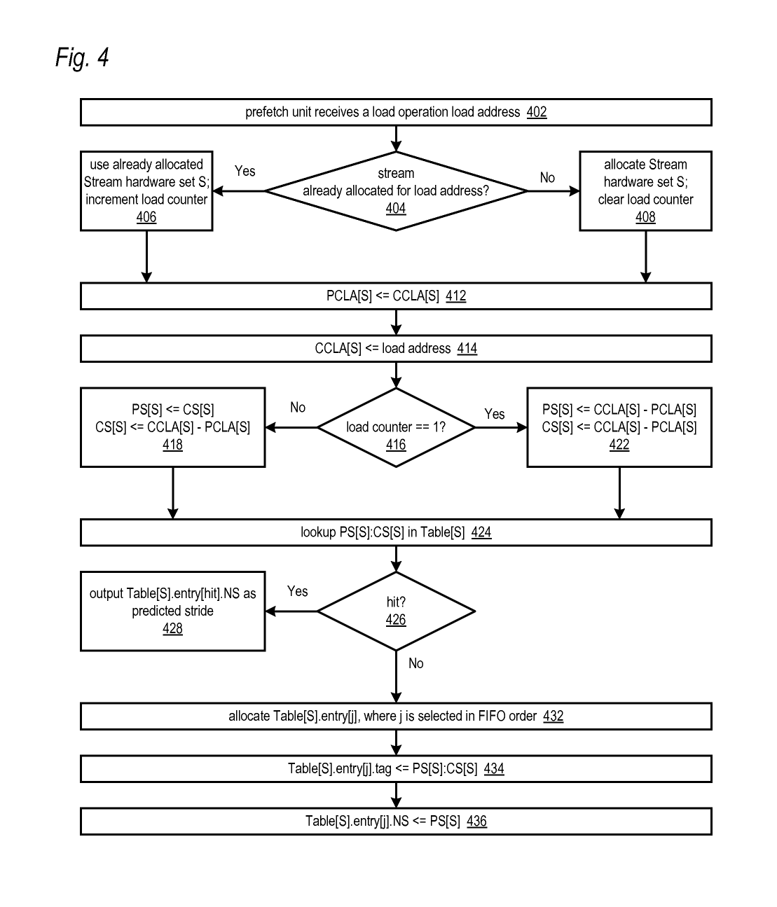

Referring now to FIG. 4, a flowchart illustrating operation of the data prefetch engine 124 of FIG. 2 according to the present invention is shown. Flow begins at block 402.

At block 402, the data prefetch engine 124 receives a load address 208 of FIG. 2 specified by a load operation. Flow proceeds to decision block 404.

At decision block 404, comparators within the control logic 206 compare bits [35:12] of the load address 208 with the stream base address 204 provided by the stream base address register 304 of each of the Stream Hardware Sets 202. A match indicates that a Stream Hardware Set 202 has already been allocated for the stream (i.e., memory region, e.g., page) implicated by the load address 208, in which case flow proceeds to block 406; otherwise, flow proceeds to block 408.

At block 406, the control logic 206 indicates an index (denoted S) of the matching Stream Hardware Set 202 for use in predicting the stride of subsequent load operations to this memory region. Additionally, the control logic 206 increments the load counter 316 of the already allocated Stream Hardware Set 202. Flow proceeds to block 412.

At block 408, the control logic 206 allocates one of the Stream Hardware Sets 202 (in a least-recently-used manner according to one embodiment) and indicates the index (denoted S) of the newly allocated Stream Hardware Set 202 for use in predicting the stride of subsequent load operations to this memory region. Additionally, the control logic 206 clears the load counter 316 of the newly allocated Stream Hardware Set 202. Flow proceeds to block 412.

At block 412, the Stream Hardware Set 202 loads the PCLA register 306 with the value of the CCLA register 308. Flow proceeds to block 414.

At block 414, the Stream Hardware Set 202 loads the CCLA register 308 with the load address 208. Flow proceeds to decision block 416.

At decision block 416, the Stream Hardware Set 202 determines whether the load counter 316 value equals one, i.e., whether this is the second load operation directed to the memory region associated with the Stream Hardware Set 202. (The steps taken at blocks 416 and 422 are an optimization to enable the data prefetch engine 124 to more accurately predict the stride in one fewer load operation in the case that the program is performing loads from strides that are equal (e.g., 3, 3, 3) and may be excluded in an alternate embodiment.) If the load counter 316 value equals one, flow proceeds to block 422; otherwise, flow proceeds to block 418.

At block 418, the Stream Hardware Set 202 loads the PS register 312 with the CS register 314 value and loads the CS register 314 with the difference between the CCLA register 308 value and the PCLA register 306 value. Flow proceeds to block 424.

At block 422, the Stream Hardware Set 202 loads both the CS register 314 and the PS register 312 with the difference between the CCLA register 308 value and the PCLA register 306 value. Flow proceeds to block 424.

At block 424, the Stream Hardware Set 202 looks up the concatenation of the values in the PS register 312 and the CS register 314 in the Table 302. Flow proceeds to decision block 426.

At decision block 426, the control logic 206 examines the hit signal 332 to determine whether the lookup performed at block 424 resulted in a hit. If so, flow proceeds to block 428; otherwise, flow proceeds to block 432.

At block 428, the Stream Hardware Set 202 outputs on stride prediction 228 the value of the NS field 326 of the Table 302 entry that hit at decision block 426. Flow ends at block 428.

At block 432, the Stream Hardware Set 202 allocates a new entry in the Table 302. In one embodiment, the Table 302 entries are allocated in first-in-first-out order. Flow proceeds to block 434.

At block 434, the Stream Hardware Set 202 loads the tag field (i.e., PS field 322 and CS field 324) of the newly allocated entry with the concatenation of the PS register 312 value and the CS register 314 value. Flow proceeds to block 436.

At block 436, the Stream Hardware Set 202 populates the data field (i.e., the NS field 326) of the newly allocated entry with the PS register 312 value. Flow ends at block 436.

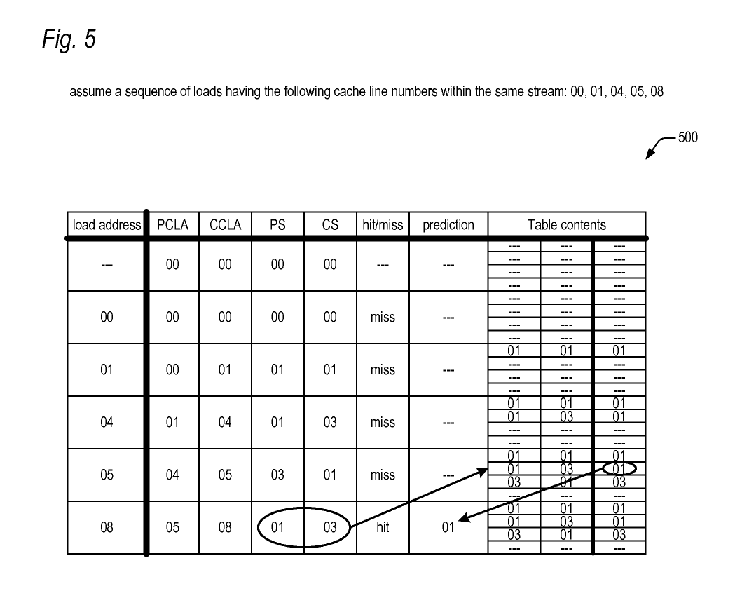

Referring now to FIG. 5, a table 500 illustrating operation of the data prefetch engine 124 of FIG. 2 according to the present invention in response to an example sequence of load operations is shown. Each row in the table 500 specifies the next input load address 208 value in the sequence. (Only the cache line numbers are shown, i.e., bits [11:6], rather than the entire load address 208.) In the example, the sequence of cache line numbers specified by the load addresses 208 is 00, 01, 04, 05, 08, which has a 01, 03, 01, 03, and so forth two-level stride pattern. Advantageously, the present invention is capable of predicting multi-level stride patterns in load accesses. Each row in the table 500 additionally indicates the contents of the PCLA register 306, CCLA register 308, PS register 312, CS register 314, and Table 302 after operation of the Stream Hardware Set 202 in response to the load address 208 input. Each row in the table 500 also specifies the value of the hit signal 332 and the stride prediction signal 228 after operation of the Stream Hardware Set 202 in response to the load address 208 input. For simplicity, the sequence in the example of FIG. 5 assumes that all the load addresses 208 are to the same memory region and therefore select the same Stream Hardware Set 202.

The first row of the table 500 indicates the initial values of the Stream Hardware Set 202. The PCLA register 306, CCLA register 308, PS register 312, and CS register 314 are all initialized to zero, and the entries of the Table 302 are all invalid.

The second row of the table 500 indicates a load address 208 value of 00. The step at block 408 is performed to allocate the new Stream Hardware Set 202, and the steps at blocks 412, 414, and 418 are performed to update the PCLA register 306, CCLA register 308, PS register 312, and CS register 314 values each to zero. Because this is the first load from the memory region, the lookup performed at block 424 results in a miss. Preferably, the Table 302 is not updated for the first load from a memory region, since there is no PCLA register 306 value from which to calculate a current stride.

The third row of the table 500 indicates a load address 208 value of 01. The steps at blocks 412, 414, and 422 are performed to update the PCLA register 306, CCLA register 308, PS register 312, and CS register 314 values to 00, 01, 00, 01, respectively. The lookup of 01:01 performed at block 424 results in a miss. Additionally, the Stream Hardware Set 202 performs the steps at blocks 432, 434, and 436 to allocate an entry in the Table 302 and populate the PS field 322, CS field 324, and NS field 326 with 01, 01, 01, respectively.

The fourth row of the table 500 indicates a load address 208 value of 04. The steps at blocks 412, 414, and 418 are performed to update the PCLA register 306, CCLA register 308, PS register 312, and CS register 314 values to 01, 04, 01, 03, respectively. The lookup of 01:03 performed at block 424 results in a miss. Additionally, the Stream Hardware Set 202 performs the steps at blocks 432, 434, and 436 to allocate an entry in the Table 302 and populate the PS field 322, CS field 324, and NS field 326 with 01, 03, 01, respectively.

The fifth row of the table 500 indicates a load address 208 value of 05. The steps at blocks 412, 414, and 418 are performed to update the PCLA register 306, CCLA register 308, PS register 312, and CS register 314 values to 04, 05, 03, 01, respectively. The lookup of 03:01 performed at block 424 results in a miss. Additionally, the Stream Hardware Set 202 performs the steps at blocks 432, 434, and 436 to allocate an entry in the Table 302 and populate the PS field 322, CS field 324, and NS field 326 with 03, 01, 03, respectively.

The sixth row of the table 500 indicates a load address 208 value of 08. The steps at blocks 412, 414, and 418 are performed to update the PCLA register 306, CCLA register 308, PS register 312, and CS register 314 values to 05, 08, 01, 03, respectively. The lookup of 01:03 performed at block 424 results in a hit because it matches the second entry of the Table 302. Consequently, the Stream Hardware Set 202 performs the step at block 428 to output the NS field 326 value (in this case 01) from the hitting Table 302 entry as the stride prediction value 228. Therefore, the data prefetch engine 124 will advantageously prefetch the cache line specified by the prefetch address 218 that is the load address 208 value plus the stride prediction 216 (in this case 01). This prefetch may save valuable time by reducing or eliminating the memory access latency that would otherwise be incurred to load the prefetched cache line.

Embodiments are contemplated in which the detection of a hit in the Table 302 triggers the prefetch of multiple cache lines according to the pattern indicated by the matching Table 302 entry. Thus, for example, the hit detected in the sixth row of FIG. 5 could trigger not only the prefetch of the cache line at stride 01, but also of the cache line at stride 03, then stride 01, then stride 03, and so forth. The number of cache line prefetches triggered may depend upon the size of the various cache memories 122 of FIG. 1 and the Stream Hardware Set 202 Table 302 sizes, as well as other factors.

Although embodiments are described in which only two stride distances are maintained in the history table and compared, other embodiments are contemplated in which a greater number are maintained in the history table and compared to accommodate more complex program access patterns.

While various embodiments of the present invention have been described herein, it should be understood that they have been presented by way of example, and not limitation. It will be apparent to persons skilled in the relevant computer arts that various changes in form and detail can be made therein without departing from the scope of the invention. For example, software can enable, for example, the function, fabrication, modeling, simulation, description and/or testing of the apparatus and methods described herein. This can be accomplished through the use of general programming languages (e.g., C, C++), hardware description languages (HDL) including Verilog HDL, VHDL, and so on, or other available programs. Such software can be disposed in any known computer usable medium such as semiconductor, magnetic disk, or optical disc (e.g., CD-ROM, DVD-ROM, etc.). Embodiments of the apparatus and method described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the exemplary embodiments described herein, but should be defined only in accordance with the following claims and their equivalents. Specifically, the present invention may be implemented within a microprocessor device which may be used in a general purpose computer. Finally, those skilled in the art should appreciate that they can readily use the disclosed conception and specific embodiments as a basis for designing or modifying other structures for carrying out the same purposes of the present invention without departing from the scope of the invention as defined by the appended claims.

We claim:

1. A data prefetcher in a microprocessor, comprising:
a table of entries, configured for maintaining on a history of load operations, each of the entries storing a tag and a corresponding next stride, wherein the tag comprises a concatenation of first and second strides, wherein the next stride comprises the first stride, wherein the first stride comprises a first cache line address subtracted from a second cache line address, wherein the second stride comprises the second cache line address subtracted from a third cache line address, wherein the first, second and third cache line addresses each comprise a memory address of a cache line implicated by respective first, second and third temporally preceding load operations; and
control logic, coupled to the table of entries, configured to calculate a current stride by subtracting a previous cache line address from a new load cache line address, look up in the table a concatenation of a previous stride and the current stride, and prefetch a cache line at a prefetch cache line address calculated as a sum of the new load cache line address and the next stride of an entry of the table in which the concatenation of the previous stride and the current stride hits;
wherein the new load cache line address comprises a memory address of a cache line implicated by a new load operation, wherein the previous cache line address comprises a memory address of a cache line implicated by a previous load operation that temporally precedes the new load operation, wherein the previous stride is the previous cache line address subtracted from a previous-to-previous cache line address, wherein the previous-to-previous cache line address comprises a memory address of a cache line implicated by a load operation that temporally precedes the previous load operation.

2. The prefetcher of claim 1, wherein the control logic is further configured to:
allocate an entry in the table, if the concatenation of the previous stride and the current stride misses in the table.

3. The prefetcher of claim 2, wherein the control logic is further configured to:
populate the tag of the allocated entry with the concatenation of the previous stride and the current stride.

4. The prefetcher of claim 3, wherein the control logic is further configured to:
populate the next stride of the allocated entry with the previous stride.

5. The prefetcher of claim 2, wherein the control logic is configured to allocate the entry in the table in first-in-first-out order.

6. The prefetcher of claim 1, further comprising:
a plurality of the tables, configured for maintaining a history of load operations within a corresponding plurality of memory regions;
wherein the control logic is further configured to:
allocate one of the plurality of tables, in response to determining that the cache line implicated by the new load address is not within any of the plurality of memory regions of the corresponding plurality of tables.

7. The prefetcher of claim 6, wherein the control logic is further configured to:
use the allocated table to perform the look up, in response to determining that one of the plurality of tables has already been allocated for the memory region that encompasses the cache line implicated by the new load address.

8. The prefetcher of claim 6, wherein the memory region comprises a 4 KB region.

9. The prefetcher of claim 1, further comprising:
a counter, incremented in response to the new load operation;
wherein the control logic is configured to calculate the previous stride as the previous cache line address subtracted from the new load cache line address rather than as the previous cache line address subtracted from a previous-to-previous cache line address, if the counter value is one after being incremented.

10. The prefetcher of claim 9, wherein the control logic is further configured to clear the counter to zero, in response to an initial use of the table.

11. The prefetcher of claim 1, wherein the control logic is further configured to additionally prefetch a second cache line at a cache line address calculated as a sum of the prefetch cache line address and the current stride of the entry in the table.

12. The prefetcher of claim 1, wherein the tag further comprises a third stride, wherein the third stride comprises the third cache line address subtracted from a fourth cache line address, wherein the fourth cache line address comprises a memory address of a cache line implicated by fourth load operation temporally preceding the third load operation, wherein the control logic is configured to look up in the table a concatenation of a previous-to-previous stride, the previous stride and the current stride, wherein the previous-to-previous stride is the previous-to-previous cache line address subtracted from a previous-to-previous-to-previous cache line address of a cache line implicated by a load operation that temporally precedes the load operation that temporally precedes the previous load operation.

13. A method for prefetching data in a microprocessor, the method comprising:
maintaining a table of entries based on a history of load operations, each of the entries storing a tag and a corresponding next stride, wherein the tag comprises a concatenation of first and second strides, wherein the next stride comprises the first stride, wherein the first stride comprises a first cache line address subtracted from a second cache line address, wherein the second stride comprises the second cache line address subtracted from a third cache line address, wherein the first, second and third cache line addresses each comprise a memory address of a cache line implicated by respective first, second and third temporally preceding load operations;
calculating a current stride by subtracting a previous cache line address from a new load cache line address, wherein the new load cache line address comprises a memory address of a cache line implicated by a new load operation, wherein the previous cache line address comprises a memory address of a cache line implicated by a previous load operation that temporally precedes the new load operation;
looking up in the table a concatenation of a previous stride and the current stride, wherein the previous stride is the previous cache line address subtracted from a previous-to-previous cache line address, wherein the previous-to-previous cache line address comprises a memory address of a cache line implicated by a load operation that temporally precedes the previous load operation; and
prefetching a cache line at a prefetch cache line address calculated as a sum of the new load cache line address and the next stride of an entry of the table in which the concatenation of the previous stride and the current stride hits.

14. The method of claim 13, further comprising:
allocating an entry in the table, if the concatenation of the previous stride and the current stride misses in the table.

15. The method of claim 14, wherein said maintaining the table comprises:
populating the tag of the allocated entry with the concatenation of the previous stride and the current stride.

16. The method of claim 15, wherein said maintaining the table comprises:
populating the next stride of the allocated entry with the previous stride.

17. The method of claim 14, wherein said allocating an entry in the table comprises allocating an entry in first-in-first-out order.

18. The method of claim 13, wherein the microprocessor includes a plurality of the tables for maintaining a history of load operations within a corresponding plurality of memory regions, the method further comprising:
allocating one of the plurality of tables, in response to determining that the cache line implicated by the new load address is not within any of the plurality of memory regions of the corresponding plurality of tables.

19. The method of claim 18, further comprising:
using the allocated table to perform the look up, in response to determining that one of the plurality of tables has already been allocated for the memory region that encompasses the cache line implicated by the new load address.

20. The method of claim 18, wherein the memory region comprises a 4 KB region.

21. The method of claim 13, further comprising:
incrementing a counter, in response to the new load operation; and
calculating the previous stride as the previous cache line address subtracted from the new load cache line address rather than as the previous cache line address subtracted from a previous-to-previous cache line address, if the counter value is one after said incrementing.

22. The method of claim 21, further comprising:
clearing the counter to zero, in response to an initial use of the table.

23. The method of claim 13, further comprising:
prefetching a second cache line at a cache line address calculated as a sum of the prefetch cache line address and the current stride of the entry in the table.

24. The method of claim 13, wherein the tag further comprises a third stride, wherein the third stride comprises the third cache line address subtracted from a fourth cache line address, wherein the fourth cache line address comprises a memory address of a cache line implicated by fourth load operation temporally preceding the third load operation, wherein said looking up in the table comprises looking up in the table a concatenation of a previous-to-previous stride, the previous stride and the current stride, wherein the previous-to-previous stride is the previous-to-previous cache line address subtracted from a previous-to-previous-to-previous cache line address of a cache line implicated by a load operation that temporally precedes the load operation that temporally precedes the previous load operation.

25. A computer program product for use with a computing device, the computer program product comprising:
a computer usable storage medium, having computer readable program code embodied in said medium, for specifying a data prefetcher in a microprocessor, the computer readable program code comprising:
first program code for specifying a table of entries, configured for maintaining on a history of load operations, each of the entries storing a tag and a corresponding next stride, wherein the tag comprises a concatenation of first and second strides, wherein the next stride comprises the first stride, wherein the first stride comprises a first cache line address subtracted from a second cache line address, wherein the second stride comprises the second cache line address subtracted from a third cache line address, wherein the first, second and third cache line addresses each comprise a memory address of a cache line implicated by respective first, second and third temporally preceding load operations; and
second program code for specifying control logic, coupled to the table of entries, configured to calculate a current stride by subtracting a previous cache line address from a new load cache line address, look up in the table a concatenation of a previous stride and the current stride, and prefetch a cache line at a prefetch cache line address calculated as a sum of the new load cache line address and the next stride of an entry of the table in which the concatenation of the previous stride and the current stride hits;
wherein the new load cache line address comprises a memory address of a cache line implicated by a new load operation, wherein the previous cache line address comprises a memory address of a cache line implicated by a previous load operation that temporally precedes the new load operation, wherein the previous stride is the previous cache line address subtracted from a previous-to-previous cache line address, wherein the previous-to-previous cache line address comprises a memory address of a cache line implicated by a load operation that temporally precedes the previous load operation.
